(19) United States
(12) Patent Application Publication
(10) Pub. No.: US 2020/0089233 A1
(43) Pub. Date: Mar. 19, 2020

(54) LOCATION OF ASSETS DEPLOYED IN CEILING OR FLOOR SPACES OR OTHER INCONVENIENT SPACES OR EQUIPMENT USING AN UNMANNED VEHICLE

(71) Applicant: CommScope Technologies LLC, Hickory, NC (US)

(72) Inventors: Morgan C. Kurk, Sachse, TX (US); David Brown, Suffolk (GB)

(73) Assignee: CommScope Technologies LLC, Hickory, NC (US)

(21) Appl. No.: 16/569,466

(22) Filed: Sep. 12, 2019

Related U.S. Application Data
(60) Provisional application No. 62/730,938, filed on Sep. 13, 2018.

(51) Int. Cl. G05D 1/00; B64C 39/02; G05D 1/02; G06K 7/10; H04W 4/80

(52) U.S. Cl. CPC G05D 1/0094; G05D 1/0088; G05D 1/0022; B64C 2201/127; G05D 1/0212; G06K 7/10099; H04W 4/80; B64C 39/024

(57) ABSTRACT

An asset having an associated tag is located using an unmanned vehicle having a tag reader. The associated tag has an identifier associated with the asset to be located stored therein. The unmanned vehicle is moved throughout a space to be searched for the asset to be located. Read operations are performed using the tag reader in the unmanned vehicle at various locations in the space to be searched. In response to successfully reading the tag associated with the asset to be located, that the asset to be located has been located is signaled. Examples of unmanned vehicles include flying drones and wheeled or continuous track vehicles. Other embodiments are disclosed.

### CROSS-REFERENCE TO RELATED APPLICATIONS

This application claims the benefit of U.S. Provisional Patent Application Ser. No. 62/730,938, filed on Sep. 13, 2018, which is hereby incorporated herein by reference in its entirety.

### BACKGROUND

Increasingly, in-building structured cabling and power infrastructure is deployed within the space between a main (structural) ceiling and a secondary (dropped or suspended) ceiling hung below the main ceiling. This space is also referred to here as the “ceiling space.” It can be challenging to locate a particular cable or power infrastructure asset (for example, a jack, plug, socket, etc.) that is deployed within a ceiling space.

Historically, existing automated infrastructure management (AIM) technology is of limited use in identifying cable and power infrastructure assets deployed in a ceiling space. Such existing AIM solutions typically focus on the identification of a port in a high-density panel deployed in a telecommunications room or a datacenter. Also, because the ports of such high-density panels are typically visible, visual indicators (such as a light emitting diodes (LEDs) or liquid crystal displays (LCDs)) are used to identify particular ports of interest. However, cable and power infrastructure assets deployed in a ceiling space are widely distributed across the entire ceiling instead of being centrally located at a single high-density panel. Also, cable and power infrastructure assets deployed in a ceiling space are not normally visible. Thus, existing AIM solutions are typically not suitable for use with cable and power infrastructure assets deployed in a ceiling space.

Conventional approaches to identifying assets that are not visible (for example, assets deployed behind a wall, buried assets, etc.) typically employ short-range wireless technology. An active or passive tag is attached to the asset. A portable wireless transceiver (also referred to as a “reader” or “interrogator”) is positioned near a tagged asset by a user. The user can cause the reader to wirelessly transmit an interrogation signal. Any tag located within the read range of the reader will receive the interrogation signal and wirelessly transmit a response signal. The response signal encodes an identifier (and, possibly, other information) associated with the tagged asset. Various types of wireless technology can be used to implement such asset tags. Examples of such wireless technology include wireless technology that supports one or more of the Institute of Electrical and Electronics Engineers (IEEE) 802.11 family of wireless standards (also referred to as “Wi-Fi technology”), one or more of the Bluetooth family of wireless standards, one or more of the IEEE 802.15.4 family of wireless standards (also referred to as “Zigbee technology”) and, most commonly, radio frequency identifier (RFID) technology. RFID technology offers three main advantages over other wireless technologies for use in tagging invisible assets. RFID technology supports the use of passive tags, thereby avoiding the need to provide local power for the tag (either via a battery or a connection to mains power). Also, RFID technology supports the use of a configurable read range. By reducing the read range, it is possible to localize or pinpoint the area in which any read tag is located, which increases the accuracy of tag location identification. Moreover, RFID technology is low cost.

Passive RFID tags typically have a maximum read range of 5 meters, but for accurate location identification a much smaller reduced read range is typically required. However, using such a smaller read range to read passive RFID tags attached to cable and power infrastructure assets deployed in ceiling spaces typically requires a technician with the portable RFID reader to position a step ladder under a portion of the suspended ceiling and climb the ladder to read any passive RFID tags deployed in the ceiling space above the suspended ceiling. Alternatively, the technician could attach the antenna of the portable RFID reader to an end of a pole in order to bring the RFID reader closer to the suspended ceiling. Both of these options are inconvenient, slow, and potentially dangerous in an occupied building.

### SUMMARY

One embodiment is directed to an unmanned vehicle configured to locate an asset having an associated tag in which an identifier associated with the asset to be located is stored. The unmanned vehicle comprises a motor configured to move the unmanned vehicle, a communication module configured to wirelessly communicate with an external vehicle-control device, and a tag reader configured to perform wireless read operations. Each read operation attempts to wirelessly read any tag that is within a read range of the tag reader.

The unmanned vehicle is configured to move the unmanned vehicle throughout a space to be searched for the asset to be located, perform read operations, using the tag reader in the unmanned vehicle, at various locations in the space to be searched, and, in response to successfully reading the tag associated with the asset to be located, signal that the asset to be located has been located.

Another embodiment is directed to a method of locating an asset having an associated tag using an unmanned vehicle having a tag reader. The associated tag has an identifier associated with the asset to be located stored therein. The method comprises moving the unmanned vehicle throughout a space to be searched for the asset to be located, performing read operations, using the tag reader in the unmanned vehicle, at various locations in the space to be searched, and, in response to successfully reading the tag associated with the asset to be located, signaling that the asset to be located has been located.

Another embodiment is directed to a system comprising an asset to be located, the asset to be located having an associated tag in which an identifier associated with the asset to be located is stored. The system further comprises an unmanned vehicle and an external vehicle-control device. The unmanned vehicle comprises a motor configured to move the unmanned vehicle, a wireless transceiver configured to wirelessly communicate with an external vehicle-control device, and a tag reader configured to perform wireless read operations. Each read operation attempts to wirelessly read any tag that is within a read range of the tag reader.

The unmanned vehicle is configured to move the unmanned vehicle throughout a space to be searched for the asset to be located, perform read operations, using the tag reader in the unmanned vehicle, at various locations in the space to be searched, and, in response to successfully reading the tag associated with the asset to be located, signal that the asset to be located has been located.

Another embodiment is directed to an unmanned vehicle configured to scan a space. The unmanned vehicle comprises a motor configured to move the unmanned vehicle, a communication module configured to wirelessly communicate with an external vehicle-control device, and a positioning system configured to determine a current location of the unmanned vehicle. The unmanned vehicle is configured to move the unmanned vehicle in or near the space to be scanned, and capture information using the unmanned vehicle at various locations in or near the space to be scanned. Each item of the captured information has associated therewith the location of the unmanned vehicle where that item was captured. The unmanned vehicle is also configured to communicate the captured information to an external device.

Another embodiment is directed to a method of scanning a space using an unmanned vehicle having a positioning system configured to determine a current location of the unmanned vehicle. The method comprises moving the unmanned vehicle in or near the space to be scanned and capturing information using the unmanned vehicle at various locations in or near the space to be scanned. Each item of the captured information having associated therewith the location of the unmanned vehicle where that item was captured. The method further comprises communicating the captured information to an external device.

Other embodiments are disclosed.

The details of various embodiments are set forth in the accompanying drawings and the description below. Other features and advantages will become apparent from the description, the drawings, and the claims.

### DRAWINGS

FIG. 1 is a block diagram illustrating one exemplary embodiment of an unmanned-vehicle-based asset location system.

FIG. 2 is one example of the unmanned-vehicle-based asset location system shown in FIG. 1 where the unmanned vehicle comprises a flying drone and the inconvenient space where tagged assets are deployed comprises a ceiling space.

FIG. 3 is one example of the unmanned-vehicle-based asset location system shown in FIG. 1 where the unmanned vehicle comprises a continuous track unmanned vehicle and the inconvenient space where tagged assets are deployed comprises a ceiling space.

FIG. 4 is one example of the unmanned-vehicle-based asset location system shown in FIG. 1 where the unmanned vehicle comprises a continuous track unmanned vehicle and the inconvenient space where tagged assets are deployed comprises a floor space.

FIG. 5 comprises a high-level flowchart illustrating one exemplary embodiment of a method of locating an asset deployed in an inconvenient space using an unmanned vehicle.

FIG. 6 illustrates one example of a search path.

FIG. 7 comprises a high-level flowchart illustrating one exemplary embodiment of a method of scanning a space of interest using an unmanned vehicle.

Like reference numbers and designations in the various drawings indicate like elements.

### DETAILED DESCRIPTION

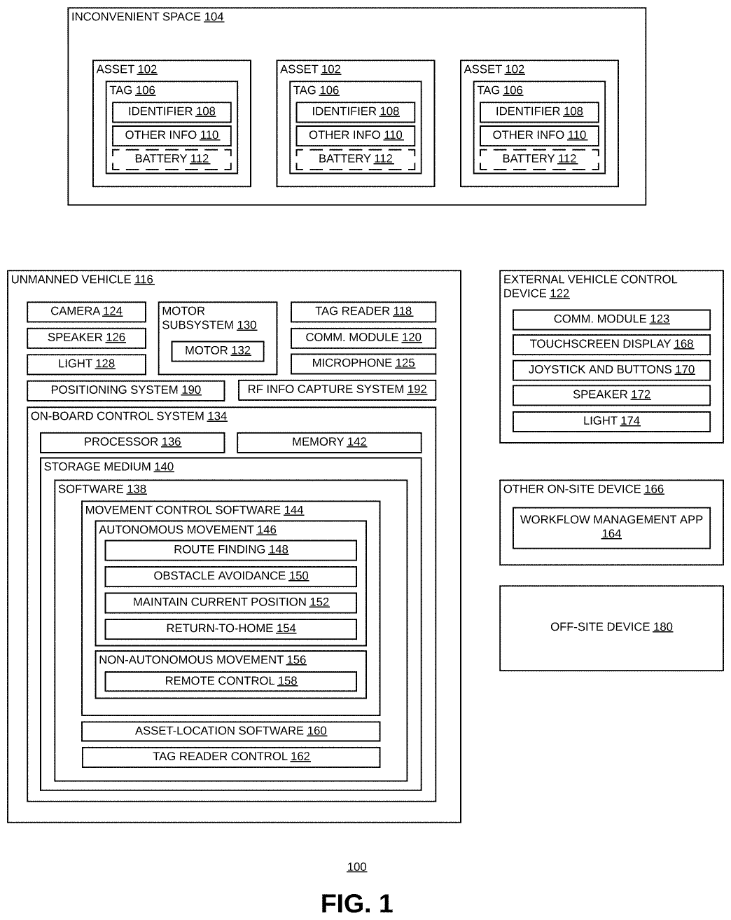

FIG. 1 is a block diagram illustrating one exemplary embodiment of an unmanned-vehicle-based asset location system 100. The system 100 is used to locate assets 102 that are deployed in spaces or equipment 104 where the assets 102 are not normally visible or are inconvenient for a person to physically access.

Examples of such assets 102 include, without limitation, structured cabling equipment used with telecommunication or computer networks (such as outlets, consolidation points, cables, cable bundles, conduits, and raceways), networking equipment (such as unlicensed and licensed frequency access points, femtocells, remote radio heads, remote antenna units, and internet-of-things (IOT) nodes (for example, IOT sensor nodes and gateways)), power equipment (such as power cables, conduits, and fuses), security equipment (such as Internet Protocol (IP) security cameras), heating, ventilation, and air conditioning (HVAC) equipment (such as conduits, cables, and sensors), lighting equipment (such as lighting fixtures and cables), elevator equipment, building-related equipment and structures, and information technology (IT) equipment.

Examples of spaces or equipment 104 where assets 102 deployed therein are not normally visible or are inconvenient for a person to physically access include, without limitation, indoor spaces or equipment such as a ceiling space between a main (structural) ceiling and a secondary (dropped or suspended) ceiling hung below the main ceiling, a floor space between a main (structural) floor and a secondary (raised) floor suspended above the main floor, spaces within walls, as well as outdoor spaces or equipment such as underground or buried spaces or equipment or a locked vault or other enclosure. A space or equipment 104 where the assets 102 deployed therein are not normally visible or are inconvenient for a person to physically access is also referred to here, for the sake of brevity, as an “inconvenient space” 104.

At least one of the assets 102 deployed in an inconvenient space 104 has at least one tag 106 attached to the asset 102 itself (or attached to some other device or structure sufficiently near the asset 102 to locate the asset 102 with the desired accuracy). In some implementations, each of the assets 102 deployed in an inconvenient space 104 has at least one tag 106 attached to or near the asset 102. For some assets 102, multiple tags 106 are attached to or near that asset 102. For example, for some cables, a separate tag 106 is attached to each end of the cable so that each end of the cable can be independently located.

Each tag 106 is configured to store an identifier 108 that can be associated with the asset 102 (or a portion or component thereof) to which the tag 106 is attached or located near. In some implementations, each tag 106 is further configured to store other information 110. Examples of such other information 110 include, without limitation, information about the tagged asset 102 itself (such as an asset type, dimensional attributes of the asset 102 (such as length, width, etc.), connectors or other components that are a part of or deployed with the asset 102), information about where the asset 102 is deployed, warning information for the asset 102 or for where or how the asset 102 is deployed (for example, information identifying any safety concerns with accessing the asset 102 or potential interruption of critical services if the asset 102 is disturbed), information about other assets or equipment to which the asset 102 is connected or otherwise used with, etc.), information about how to access or service the asset 102, and service history information for the asset 102. The other information 110 can include other types of information.

In one implementation, each tag 106 comprises a controller, a short-range wireless transponder or transceiver coupled to the controller, an antenna coupled to the wireless transceiver, and a storage device (for example, a non-volatile memory such as an electrically erasable programmable read-only memory (EEPROM)) coupled to the controller and in which the identifier 108 and other information 110 is stored and from which it is read. Each tag 106 can be implemented in other ways.

The identifier 108 and other information 110 can be written to the tag 106 in the factory and/or when the asset 102 is deployed in the inconvenient space 104. Also, in some implementations, at least some of the tags 106 are configured so that the information stored in the tag 106 can be updated while the asset 102 is deployed in the inconvenient space 104.

Each tag 106 is configured so that the identifier 108 and other information 110 stored in that tag 106 can be wirelessly read by an appropriate reader. Generally, this involves the reader wirelessly transmitting an interrogation signal. If the tag 106 is located within the read range of the reader, the tag 106 will receive the interrogation signal. In response to receiving the interrogation signal, the tag 106 will wirelessly transmit a response signal that encodes the identifier 108 (and, in some implementations, other information 110) for reception by the reader.

Any of various types of wireless technology can be used to implement each tag 106. Examples of such wireless technology include W-Fi technology, Zigbee technology, and, most commonly, RFID technology. Each tag 106 can be implemented as an active tag (in which case the tag 106 would also include a battery 112 or connection to mains power) or as a passive tag (in which case the tag 106 would not need to include a battery 112 or connection to mains power and instead would be powered by the interrogational signal). The various tags 106 used in the system 100 do not need to all be implemented in the same way. Also, an asset 106 can be tagged using multiple different types of tags 106. For example, an asset 106 can be tagged with an active tag 106 and a passive tag 106, where the active tag 106 serves as a “primary” tag and the passive tag 106 serves as a “backup” tag in the event that the active tag 106 fails (for example, due to a lack of power). Also, an asset 106 can be tagged with multiple different types of tags 106 in order to support multiple different types of readers and wireless technology.

The system 100 further comprises an unmanned vehicle 116 equipped with a tag reader 118. Examples of unmanned vehicles 116 include, without limitation, flying drones, wheeled vehicles, and continuous-track vehicles. The tag reader 118 is configured to be able to read the type or types of tags 106 that are attached to or near the assets 102 deployed in the inconvenient space 104. For example, where the tags 106 comprise RFID tags, the tag reader 118 comprises an RFID tag reader configured to read RFID tags.

The unmanned vehicle 116 also comprises a communication module 120 (comprising an appropriate wireless transceiver) that is configured to communicate with an external vehicle-control device 122 that a user can use to interact with the unmanned vehicle 116. The communication module 120 and external vehicle-control device 122 implement and use a suitable wireless communication protocol for such communications and interactions. The external vehicle-control device 122 can be located on-site with the inconvenient space 104 or off-site at a remote location.

The external vehicle-control device 122 can comprise a special-purpose device (such as a remote-control (RC) controller) or a general-purpose device (such as a laptop, tablet, smartphone, etc.) that is outfitted with suitable software and wireless transceiver. The external vehicle-control device 122 includes a communication module 123 configured to communicate with the unmanned vehicle 116 using the appropriate wireless communication protocol. The external vehicle-control device 122 also includes one or more user input/output (I/O) devices configured to display information for, and receive input from, the user. Examples of user I/O devices include, without limitation, LCD displays (including touchscreen and non-touchscreen LCD displays), lights, speakers, keyboards, buttons, track pads, joysticks, switches, and buttons. In the example shown in FIG. 1, the external vehicle-control device 122 comprises, without limitation, a touchscreen LCD display 168, a joystick and buttons 170, a speaker 172, and a light 174.

The unmanned vehicle 116 also comprises one or more of: a camera 124 for capturing video or still images of the scene near the unmanned vehicle 116, a microphone 125, a speaker 126 for playing sounds for a user, a light 128 (for example, an LED and/or a laser pointer) that can be illuminated in order to provide a visual indication to a user and/or to illuminate the scene captured by the camera 124.

The unmanned vehicle 116 comprises a motor subsystem 130 that includes a motor 132 and other conventional unmanned vehicle components (such as propellers, wheels, rudders, brakes, actuators, sensors, etc.) that are configured to physically move (and physically control the movement of) the unmanned vehicle 116.

The unmanned vehicle 116 also comprises an on-board control subsystem 134 that generally controls the operations of the unmanned vehicle 116 including, without limitation, controlling the movement of the unmanned vehicle 116 by interacting with the motor subsystem 130. In the exemplary embodiment shown in FIG. 1, the on-board control system 134 comprises at least one programmable processor 136 on which software or firmware 138 executes. The software 138 comprises program instructions that are stored (or otherwise embodied) on an appropriate non-transitory storage medium or media 140 from which at least a portion of the program instructions are read by the programmable processor 136 for execution thereby. The software 138 is configured to cause the processor 136 to carry out at least some of the operations described here as being performed by the unmanned vehicle 116. Although the storage medium 140 is shown in FIG. 1 as being included in the unmanned vehicle 116, it is to be understood that remote storage media (for example, storage media that is accessible over a network) and/or removable media can also be used. In one aspect illustrated in FIG. 1, the unmanned vehicle 116 also comprises memory 142 for storing the program instructions and any related data during execution of the software 138.

The software 138 comprises movement control software 144 that is configured to control the movement of the unmanned vehicle 116 by interacting with the motor subsystem 130. The movement control software 144 comprises autonomous movement functions 146 that implement various autonomous movement operations that include, for example, route-finding functions 148 configured to cause the unmanned vehicle 116 to automatically determine the path it moves along, obstacle avoidance functions 150 configured to cause the unmanned vehicle 116 to automatically avoid obstacles while the unmanned vehicle 116 is otherwise moving, maintain-current-position functions 152 to cause the unmanned vehicle 116 to maintain its current position (for example, by hovering where the unmanned vehicle 116 is implemented as a flying drone or by braking where the unmanned vehicle 116 is implemented as a wheeled or continuous-track vehicle), and return-to-home functions 154 configured to cause the unmanned vehicle 116 to automatically return to the location where the unmanned vehicle 116 started its current mission. The autonomous movement functions 146 can include other autonomous movement operations.

The movement control software 138 also comprises non-autonomous movement functions 156 including, for example, remote-control functions 158 configured to enable a user to remotely control the movement of the unmanned vehicle 116 (for example, using the external vehicle-control device 122).

The software 138 also comprises asset-location software 160 that is configured to cause the unmanned vehicle 116 to carry out a mission involving moving the vehicle 116 in or near the inconvenient space 104 while using the tag reader 118 to read tags 106 from various positions in or near the inconvenient space 104. The software 138 also comprises tag reader control software 162 configured to interact with and control the tag reader 118.

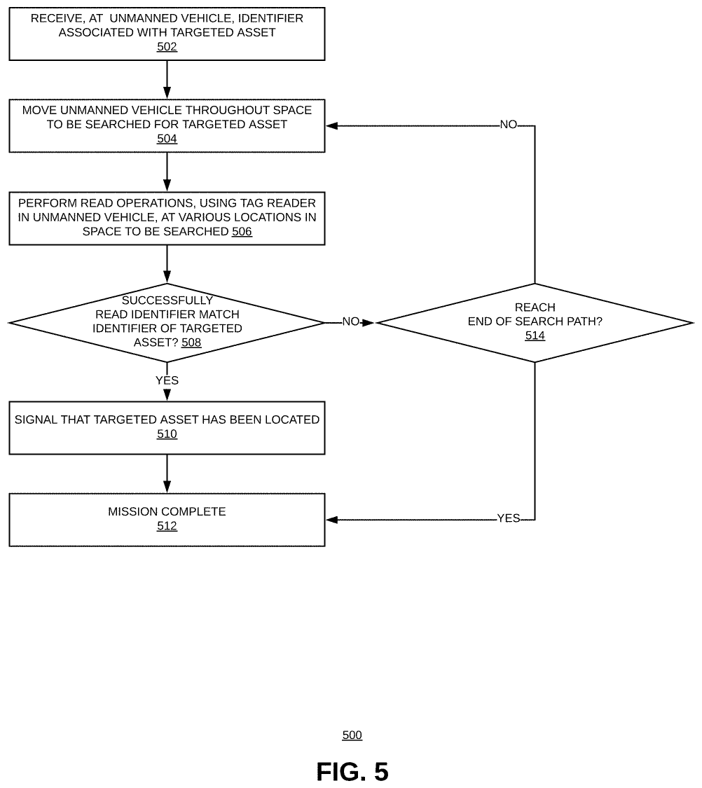

The unmanned vehicle 116 is configured to locate an asset 102 having an associated tag 106 in which an identifier 108 associated with the asset 102 to be located is stored. The unmanned vehicle 116 is configured to move the unmanned vehicle 116 throughout a space to be searched for the asset 102 to be located, perform read operations, using the tag reader 118 in the unmanned vehicle 116, at various locations in the space to be searched, and, in response to successfully reading the tag 106 associated with the asset 102 to be located, signal that the asset 102 to be located has been located. Additional details regarding how this can be implemented is described below in connection with FIG. 5.

The unmanned vehicle 116 can also comprise one or more positioning systems 190 configured to determine the current geographic location of the unmanned vehicle 116. Examples of suitable positioning systems 190 include, without limitation, a system based on a Global Navigation Satellite System (GNSS) (such as the Global Positioning System (GPS)), a cellular-based positioning system (for example, a positioning system relying on positioning information provided by a cellular chipset used in the communication module 120), and an indoor positioning system (for example, an indoor positioning system that uses range measurements from one or more beacons or other landmarks and/or uses dead reckoning from known geographic locations). The positioning system 190 can be implemented in other ways.

The unmanned vehicle 116 can also comprise a radio frequency (RF) information capture system 192 configured to capture information about the RF environment in which the unmanned vehicle 116 operates. For example, the RF information capture system 192 can comprise a software-defined radio that can selectively capture information about one or more RF channels or bands of interest (including both licensed and unlicensed RF channels or bands). The RF information capture system 192 can be implemented in other ways. Examples of information that can be captured include, without limitation, particular measurements for the RF channel or band of interest (for example, received signal strength indication (RSSI) measurements and/or signal-to-noise-plus-interference ratio (SNIR) measurements) and digitized versions of the RF spectrum for the channel or band of interest that is suitable for offline analysis. Other RF information can be captured.

As noted above, various types of unmanned vehicles 116 can be used to locate various types of assets 102 that are deployed in various types of inconvenient spaces 104.

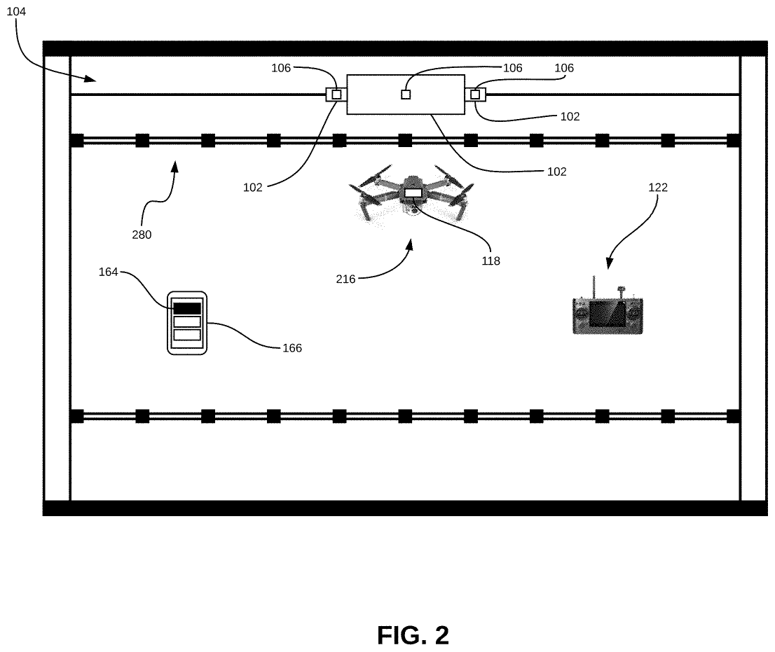

In one example illustrated in FIG. 2, the unmanned vehicle 116 comprises a flying drone 216, and the inconvenient space 104 in which tagged assets 102 are deployed comprise a ceiling space. The space to be searched comprises the space under a dropped ceiling 280. In such an example, a technician can place the flying drone 216 on the floor under the starting point of the search path, turn on the flying drone 216, and initiate an asset-location and/or scanning mission (for example, using the external vehicle-control device 122). In response to initiating the asset-location and/or scanning mission, the flying drone 216 will take off and ascend vertically until it is close enough to the dropped ceiling 280 that the tag reader 118 in the flying drone 216 is able to read tags 106 deployed in the ceiling space. Once the flying drone 216 is close enough to the dropped ceiling, it will commence flying horizontally under the dropped ceiling 280 along the search path and perform the actions described below in connection with FIG. 5. Alternatively, the technician can turn on the flying drone 216 and remotely pilot the flying drone 216 to the starting point of the search path and vertically position the flying drone 216 so that it is close enough to the dropped ceiling 280 that tag reader 118 in the flying drone 216 is able to read tags 106 deployed in the ceiling space. Then, the technician can initiate the asset-location and/or scanning mission, which causes the flying drone 216 to move along the search path and perform the actions described below in connection with FIGS. 5 and/or 7. The flying drone 216 can be brought to the starting point of the scan path in other ways.

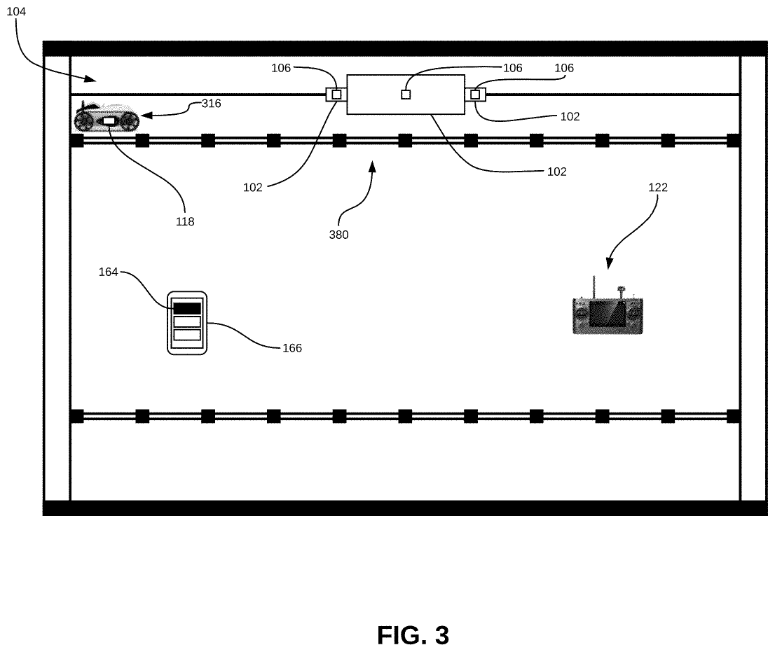

In another example illustrated in FIG. 3, the unmanned vehicle 116 comprises a continuous track unmanned vehicle 316, and the inconvenient space 104 in which tagged assets 102 are deployed comprises a ceiling space. In such an example, a technician can use a step ladder to gain access to the ceiling space to be searched, place the continuous track unmanned vehicle on the upper side of the dropped ceiling 380 at the starting point of the search path, turn on the continuous track unmanned vehicle 316, and initiate an asset-location and/or scanning mission (for example, using the external vehicle-control device 122), which causes the continuous track unmanned vehicle 316 to move along the search path along the upper side of the dropped ceiling 380 and perform the actions described below in connection with FIGS. 5 and/or 7. The continuous track unmanned vehicle 316 can be brought to the starting point of the search path in other ways.

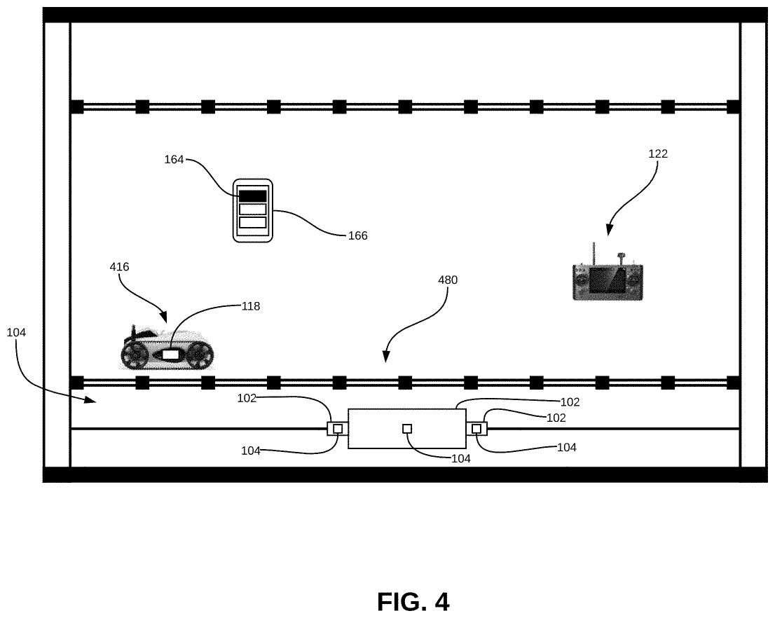

In another example illustrated in FIG. 4, the unmanned vehicle 116 comprises a continuous track unmanned vehicle 416, and the inconvenient space 104 in which tagged assets 102 are deployed comprises a floor space. In such an example, a technician can place the continuous track unmanned vehicle 414 on the upper side of the raised floor 480 at the starting point of the search path, turn on the continuous track unmanned vehicle 416, and initiate an asset-location and/or scanning mission (for example, using the external vehicle-control device 122), which causes the continuous track unmanned vehicle 416 to move along the search path along the upper side of the raised floor 480 and perform the actions described below in connection with FIGS. 5 and/or 7. The continuous track unmanned vehicle 416 can be brought to the starting point of the search path in other ways.

FIG. 5 comprises a high-level flowchart illustrating one exemplary embodiment of a method 500 of locating an asset deployed in an inconvenient space using an unmanned vehicle. The embodiment of method 500 shown in FIG. 5 is described here as being implemented in the system 100 described above in connection with FIG. 1, though it is to be understood that other embodiments can be implemented in other ways.

The blocks of the flow diagram shown in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel and/or in an event-driven manner). Also, most standard exception handling is not described for ease of explanation; however, it is to be understood that method 500 can and typically would include such exception handling.

The particular asset 102 to be located that method 500 is described here as being performed for is also referred to here as the “targeted” asset 102.

Method 500 comprises receiving, at the unmanned vehicle 116, an identifier 108 associated with the targeted asset 102 (block 502). In this particular embodiment, the identifier 108 that is provided to the unmanned vehicle 116 is the identifier 108 stored in a tag 106 that is attached to or near the targeted asset 102. The identifier 108 stored in the tag 106 associated with the targeted asset 102 can be wirelessly communicated to the unmanned vehicle 116 from a workflow management application 164 executing on a smartphone, tablet, or other computing device 166 used by a user in connection with carrying out a workflow involving the targeted asset 102 and/or from an off-site external device 180. The identifier 108 is then received by the unmanned device 116 (via the communication module 120), where it is used by the asset-location software 160.

The identifier 108 stored in the tag 106 associated with the targeted asset 104 can be provided to the unmanned vehicle 116 in other ways (for example, by having a user use a the touchscreen display 168 (or other user input mechanism) of the external vehicle-control device 122 to manually enter the identifier 108 and then cause the external vehicle-control device 122 to wirelessly communicate the entered identifier 108 to be wirelessly communicated to the unmanned vehicle 116).

Method 500 further comprises moving the unmanned vehicle 116 throughout a space to be searched for the targeted asset 102 (block 504). More specifically, in this exemplary embodiment, the unmanned vehicle 116 is moved along a search path in or near the inconvenient space 104 in which the targeted asset 102 is deployed.

As used here, a “search path” refers to the path that the unmanned vehicle 116 travels while it moves throughout the space that is searched for the targeted asset 102. In general, the search path is configured to move the unmanned vehicle 116 in a space where the unmanned vehicle 116 is expected to be able to locate the targeted asset 102 (for example, by moving in the inconvenient space 104 in which the targeted asset 102 is deployed itself (for example, as shown in the examples of FIGS. 3 and 4) or by moving outside but near the inconvenient space 104 in which the targeted asset 102 is deployed (for examples, as shown in the example of FIG. 2)). The search path need not cover the entire room or other space of interest if it is possible to localize where the targeted asset 102 is likely to be found. For example, if it is known that assets 102 are deployed in only a portion of the inconvenient space 104 of interest, then the unmanned vehicle 116 can be configured to use a search path associated with that portion of the inconvenient space 104. However, if it is not possible to localize where the targeted asset 102 is likely to be found, the unmanned vehicle 116 can be configured to use a search path associated with the entire inconvenient space 104 of interest.

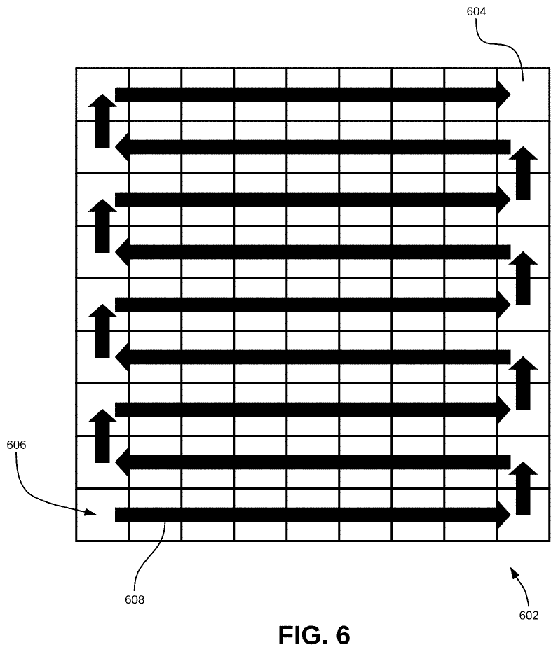

One example of a search path is illustrated in FIG. 6. FIG. 6 shows a plan view looking up towards a dropped ceiling 602 or looking down towards a raised floor 602. The dropped ceiling 602 or raised floor 602 comprises a grid of tiles 604. The example search path illustrated in FIG. 6 starts in one corner 606 of the space to be searched and travels in a serpentine pattern 608 that traverses the space to be search. Other search patterns can be used.

In some implementations, the unmanned vehicle 116 moves along the search path in an autonomous mode. In such implementations, moving the unmanned vehicle 116 along a search path in or near the inconvenient space 104 to be searched involves bringing the unmanned vehicle 116 to or near the starting point of the search path and initiating an asset-location mission. For example, a technician can carry the unmanned vehicle 116 to or near the inconvenient space 104 to be searched and place it at or near a starting point of the search path. A technician can then turn on the unmanned vehicle 116 and use the external vehicle-control device 122 to initiate the asset-location mission, which causes the unmanned vehicle 116 to autonomously move to the starting point of the search path (if the unmanned vehicle 116 is not already at the starting point) and to autonomously move along the search path. Alternatively, the technician can use the external vehicle-control device 122 to remotely drive or pilot the unmanned vehicle 116 to the starting point of the search path and initiate the asset-location mission, which causes the unmanned vehicle 116 to autonomously move to the starting point of the search path (if the unmanned vehicle 116 is not already at the starting point) and to autonomously move along the search path.

In implementations where the unmanned vehicle 116 moves along the search path in an autonomous mode, the search path can be defined offline and uploaded to the unmanned vehicle 116. For example, such a search path can be defined by specifying the geographic coordinates for waypoints along the desired search path and then uploading the specified geographic coordinates to the unmanned vehicle 116. In this case, the route-finding functions 148 are used to move the unmanned vehicle 116 between the waypoints and the obstacle avoidance functions 150 of the unmanned vehicle 116 are used as a secondary measure to avoid collisions with obstacles that are encountered along the primary route of the search path.

Alternatively, the search path can be determined dynamically (on-the-fly) by the unmanned vehicle 116 as it autonomously moves. In this case, the route-finding functions 148 use the obstacle avoidance functions 150 in connection with determining the primary route for the search path (in addition to using the obstacle avoidance functions 150 to avoid collisions with obstacles that are encountered along the primary route of the search path). For example, the unmanned vehicle 116 can be configured to travel along a first primary direction until it encounters an obstacle. When the unmanned vehicle 116 encounters an obstacle, it attempts to move around the obstacle and continue along the current primary direction. If the unmanned vehicle 116 encounters an obstacle it is not able to move around (for example, a wall), the unmanned vehicle 116 moves perpendicular to the current primary direction for a predetermined distance and then moves along a new primary direction that is the opposite of (that is, 180 degrees relative to) the most-recent primary direction of travel. This results in the unmanned vehicle 116 traveling in a serpentine pattern (for example, as shown in FIG. 6). As described in more detail below, this dynamic route-finding process is repeated until the tag 106 associated with the targeted asset 102 is read or the unmanned vehicle 116 reaches a predetermined end point or encounters an obstacle in the perpendicular direction that it is unable to move around. Other approaches to autonomous route-finding can be used to determine the search path of the unmanned vehicle 116.

In other implementations, the unmanned vehicle 116 is moved in a non-autonomous mode in which a technician uses the external vehicle-control device 122 to remotely drive or pilot the unmanned vehicle 116 along a search path. In such implementations, moving the unmanned vehicle 116 along a search path in or near the inconvenient space 104 to be searched involves bringing the unmanned vehicle 116 to or near the starting point of the search path (for example, by having the technician carry the unmanned vehicle 116 or remotely drive or pilot the unmanned vehicle 116 to or near the starting point of the search path) and then having the technician use the external vehicle-control device 122 to remotely drive or pilot the unmanned vehicle 116 to the starting point of the search path (if the unmanned vehicle 116 is not already at the starting point) and to remotely drive or pilot the unmanned vehicle 116 along the search path.

Referring again to FIG. 5, method 500 further comprises performing read operations, using the tag reader 118 in the unmanned vehicle 116, at various locations in the space to be searched (block 506). When a read operation is performed, the tag reader 118 in the unmanned vehicle 116 attempts to read any tag 106 that is in the current read range of the tag reader 118. The unmanned vehicle 116 can periodically stop along the search path and perform a read operation. The unmanned vehicle 116 can also perform read operations as the unmanned vehicle 116 is in motion.

The unmanned vehicle 116 can be configured to perform each successive read operation after the unmanned vehicle 116 has moved a configurable predetermined distance since the last read operation was performed. Also, the unmanned vehicle 116 can be configured to perform read operations at predetermined locations along the search path (for example, at particular waypoints defined for the search path). The predetermined read locations can be defined offline (for example, by specifying the geographic coordinates for such locations) and uploaded to the unmanned vehicle 116.

Method 500 further comprises checking if each identifier 108 successfully read from a tag 106 matches the identifier of the targeted asset 102 (block 508).

Method 500 further comprises, if the checked identifier 108 matches the identifier of the targeted asset 102, signaling that the targeted asset 102 has been located (block 510). This signaling can occur in various ways. For example, the unmanned vehicle 116 can stop where it read the identifier 108 that matches the identifier of the targeted asset 102 (and hover if the unmanned vehicle 116 comprises a flying drone) and play a sound on the speaker 126 in the unmanned vehicle 116 and/or a speaker 172 in the external vehicle-control device 122, illuminate a light 128 of the unmanned vehicle 116 (for example, using laser point to point to a spot on the ceiling or floor) and/or a light 174 in the external vehicle-control device 122, and/or send a message to the external vehicle-control device 122, other on-site portable device 166, and/or other off-site external device 180 for display thereon. Such a message can also include the geographic location of the unmanned vehicle 116 when the matching tag 106 was read (as determined by or via the positioning system 190 in the unmanned vehicle 116). In response to this signaling, a technician can view images captured using the camera 124 in the unmanned vehicle 116 in order to look at the area where the unmanned vehicle 116 read the identifier 108 that matches the identifier of the targeted asset 102.

In implementations where the unmanned vehicle 116 moves within the inconvenient space 104 to be searched (for example, where the unmanned vehicle 116 moves within a ceiling space or flooring space), the technician can view the images captured using the camera 124 to inspect the targeted asset 102 and the area around it. The technician can use the external vehicle-control device 122 in order to maneuver the camera 124 and/or the unmanned vehicle 116 as necessary to change what can be seen in the images captured by the camera 124 and displayed on the display 168 of the external vehicle-control device 122.

In implementations where the unmanned vehicle 116 does not move within the inconvenient space 104 to be searched but instead moves near the inconvenient space 104 to be searched (for example, where the unmanned vehicle 116 moves below a dropped ceiling or on a raised floor), the technician can view images captured using the camera 124 to inspect the surrounding area in order to see how to gain access to the targeted asset 102. For example, where the unmanned vehicle 116 moves below a dropped ceiling or on a raised floor, one or more ceiling or floor tiles that need to be removed in order to gain access to the targeted asset 102 can be identified using the captured images. The technician can use the external vehicle-control device 122 in order to maneuver the camera 124 and/or the unmanned vehicle 116 as necessary to change what can be seen in the images captured by the camera 124 and displayed on the display 168 of the external vehicle-control device 122.

Also, other information 110 read from the tag 106 of the targeted asset 102 can be displayed for the technician. As noted above, this other information 110 can include, for example, information about the targeted asset 102 itself (such as an asset type, dimensional attributes of the asset (such as length, width, etc.), connectors or other components that are a part of or deployed with the targeted asset 102), information about where the targeted asset 102 is deployed, warning information for the targeted asset 102 or warning information for where or how the asset 102 is deployed (for example, information identifying any safety concerns with accessing the targeted asset 102 or potential interruption of critical services if the targeted asset 102 is disturbed), information about other assets or equipment to which the asset 102 is connected or otherwise used with, etc.), information about how to access or service the targeted asset 102, and service history information for the targeted asset 102.

After the technician determines the location of the targeted asset 102 and has reviewed any associated information or images, the technician can use the external vehicle-control device 122 to cause the unmanned vehicle 116 to return to the start of the search path (and land if a flying drone is used). At this point, the current mission is complete (block 512) and the technician can proceed with accessing the targeted asset 102 for whatever reason prompted the need to locate the targeted asset 102 (for example, to carry out a workflow that involves the targeted asset 102).

Method 500 further comprises, if a checked identifier 108 does not match the identifier of the targeted asset 102 and the unmanned vehicle 116 has not reached the end of the search path (checked in block 514), continuing to move the unmanned vehicle 116 along the search path in or near the inconvenient space 104 to be searched and to perform additional read operations using the tag reader 118 in the unmanned vehicle 116 at various locations in the space to be searched (looping back to block 504).

If the unmanned vehicle 116 reaches the end of the search path (checked in block 514) without having read a matching identifier from a tag 106, the mission can be considered unsuccessful and complete (block 512). When this happens, the unmanned vehicle 116 can return to the starting point of the search path and perform another asset-location mission using a different search space, a different search path, and/or a different set of reading locations. For example, a larger search space can be used. Also, the same search space can be used but with a different search path (for example, a higher-resolution search path that causes the unmanned vehicle 116 to travel across a larger portion of the search space). Also, the same search space and the same search path can be used but with a different set of reading locations (for example, a higher-resolution set of reading locations can be used that involves a greater number of reading location).

Moreover, if the previous unsuccessful asset-location mission was performed in an autonomous mode, another asset-location mission can be performed with the technician remotely driving or piloting the unmanned vehicle 116 for at least a portion of the mission. Furthermore, if the asset-location mission is unsuccessful, the technician can perform a manual search for the targeted asset 106 using a portable tag reader in the conventional manner described above.

By using an unmanned vehicle 116 to search for and identify an asset 102 deployed in an inconvenient space 104, a technician can avoid having to perform a manual search for the asset 106 using a portable tag reader (assuming the unmanned vehicle 116 is able to successfully search for and locate the asset 102). This can be a safer and more convenient approach to locating assets 106 deployed in such inconvenient spaces 104.

The exemplary embodiments of system 100 and method 200 described above in connection with FIGS. 1-6 are only examples of such a system and method and it is to be understood that other embodiments can be implemented in other ways.

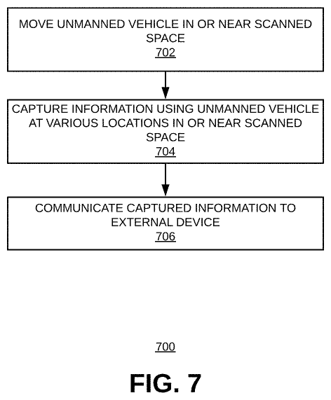

For example, in an alternative embodiment, instead of (or in addition to) locating a particular tagged asset as described above in connection with FIG. 5, a space of interest can be “scanned” using an unmanned vehicle 116 in order to assemble a map of all tags (and tagged assets) that are located in that space and/or to assemble a map of the RF environment. One such example is illustrated in FIG. 7.

FIG. 7 comprises a high-level flowchart illustrating one exemplary embodiment of a method 700 of scanning a space of interest using an unmanned vehicle. The embodiment of method 700 shown in FIG. 7 is described here as being implemented in the system 100 described above in connection with FIG. 1, though it is to be understood that other embodiments can be implemented in other ways.

The blocks of the flow diagram shown in FIG. 7 have been arranged in a generally sequential manner for ease of explanation; however, it is to be understood that this arrangement is merely exemplary, and it should be recognized that the processing associated with method 700 (and the blocks shown in FIG. 7) can occur in a different order (for example, where at least some of the processing associated with the blocks is performed in parallel and/or in an event-driven manner). Also, most standard exception handling is not described for ease of explanation; however, it is to be understood that method 700 can and typically would include such exception handling.

Method 700 comprises moving the unmanned vehicle 116 in or near the scanned space (block 702). This can be done in the same manner described above in connection with FIGS. 5 and 6, except that the search path described above in connection with FIGS. 5 and 6 can be referred to in connection with FIG. 7 as the “scan path.”

Method 700 further comprises capturing information at various locations in or near the scanned space using the unmanned vehicle 116 (block 704).

For example, the tag reader 118 in the unmanned vehicle 116 can be used to perform read operations at various locations in or near the scanned space. This can be done in the same manner described above in connection with FIGS. 5 and 6. This captured information can include the geographic location of each read operation (determined by or via the positioning system 190 in the unmanned vehicle 116), whether the read operation was successful or not, and if successful, the identifier 108 (and any other information 110) read from the associated tag 106.

In addition to, or instead of, tag information captured using the tag reader 118, information about the RF environment can be captured using the RF information capture system 192 in the unmanned vehicle 116. For example, this can be done for a particular RF channel or band of interest. This can be done in the same general manner that tag information is captured using the tag reader 118, except that information about the RF environment is captured for the RF channel or band of interest along with the geographic location of the location where each such capture operation is performed (determined by or via the positioning system 190 in the unmanned vehicle 116).

Moreover, the capture of information about the RF environment can be triggered based on whether or not a tag 106 has been successfully read and/or based on the identifier 108 or other information 110 read from a tag 106. In one example, when a tag 106 has been successfully read, then information about the RF environment for the RF channel or band of interest is captured. In another example, each time a tag 106 associated with certain types of assets 102 is successfully read (for example, each time a tag 106 associated wireless networking equipment is successfully read), information about the RF environment for the RF channel or band of interest is captured.

Method 700 further comprises communicating the captured information to an external device (block 706). This can be done in real-time as the information is being captured and/or after the mission is completed. Also, the captured information can be communicated to an external device 166 that is on-site with the unmanned vehicle 116 or to an external device 180 that is off-site (for example, to an external device 180 at a monitoring or management facility operated by the same enterprise that owns the on-site location or at a monitoring or management facility operated by a third-party). Moreover, the captured information can be communicated to the external vehicle control device 122, from which the captured information can be used, stored, and/or communicated to another device or system.

In the embodiments described above, the external devices with which the unmanned vehicle 116 communicates are primarily depicted as being on-site at the same location as the unmanned vehicle 116 and the targeted asset 102. However, in other embodiments, the unmanned vehicle 116 communicates with off-site devices (for example, an off-site external vehicle-control device 122 and/or other off-site devices 180). For example, in one exemplary usage scenario, the unmanned vehicle 116 can be shipped from an off-site location to an on-site location. A local person at the on-site location can be instructed to remove the unmanned vehicle 116 from the relevant shipping container, place the unmanned vehicle 116 in the space to be searched or scanned, and power on the unmanned vehicle 116. The local person can be provided with the relevant instructions from printed materials provided with the unmanned vehicle 116 and/or by communicating with an off-site technician (for example, via a voice call). The unmanned vehicle 116 can then locate a particular tagged asset 102 (as described above in connection with FIG. 5) and/or scan the space (as described above in connection with FIG. 7). The unmanned vehicle 116 can carry out such a mission in a fully autonomous manner and/or under remote control of an off-site technician that remotely pilots or drives the unmanned vehicle 116 (via a suitable wireless communication link). Any information captured during the mission can be communicated to an off-site device 180 or technician for off-site use. After the mission is complete, the local person can be instructed to power-down the unmanned vehicle 116 and ship it back to the off-site location. The off-site location can be a monitoring or management facility operated by the same enterprise that owns the on-site location or at a monitoring or management facility operated by a third-party.

In another embodiment, a space of interest is scanned using an unmanned vehicle 116 in order to assemble a map of all tags (and tagged assets) that are located in that space and/or to assemble a map of the RF environment (as described above in connection with FIG. 7) while, during the same mission, the unmanned vehicle 116 is used to locate a particular tagged asset (as described above in connection with FIG. 5). In such an embodiment, after the targeted tagged asset has been located and its location has been signaled, instead of considering the mission complete at that point as described above in connection with FIG. 5, the unmanned vehicle 116 can continue to scan the space of interest until the entire space of interest has been scanned. Other combinations of method 500 of FIG. 5 and method 700 of FIG. 7 are possible.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes an unmanned vehicle configured to locate an asset having an associated tag in which an identifier associated with the asset to be located is stored, the unmanned vehicle comprising: a motor configured to move the unmanned vehicle; a communication module configured to wirelessly communicate with an external vehicle-control device; and a tag reader configured to perform wireless read operations, each read operation attempting to wirelessly read any tag that is within a read range of the tag reader; wherein the unmanned vehicle is configured to: move the unmanned vehicle throughout a space to be searched for the asset to be located; perform read operations, using the tag reader in the unmanned vehicle, at various locations in the space to be searched; and in response to successfully reading the tag associated with the asset to be located, signal that the asset to be located has been located.

Example 2 includes the unmanned vehicle of Example 1, wherein the unmanned vehicle comprises one of a flying drone, wheeled vehicle, and a continuous track vehicle.

Example 3 includes the unmanned vehicle of any of Examples 1-2, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

Example 4 includes the unmanned vehicle of any of Examples 1-3, wherein the asset to be located is deployed in one of: a space or enclosure in which the asset to be located is not normally visible and a space or enclosure in which the asset to be located is inconvenient for a person to access.

Example 5 includes the unmanned vehicle of any of Examples 1-4, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

Example 6 includes the unmanned vehicle of any of Examples 1-5, wherein the unmanned vehicle is configured to: receive the identifier associated with the asset to be located; and checking if each respective associated identifier from each successfully read tag matches the identifier associated with the asset to be located; wherein the tag associated with the asset to be located is considered to have been successfully read if the respective associated identifier from a successfully read tag matches the identifier associated with the asset to be located.

Example 7 includes the unmanned vehicle of Example 6, wherein the unmanned vehicle is configured to receive the identifier associated with the asset to be located from at least one of: a workflow management application; and the external vehicle-control device via which the identifier associated with the asset to be located has been entered.

Example 8 includes the unmanned vehicle of any of Examples 1-7, wherein the unmanned vehicle is configured to signal that the asset to be located has been located by doing at least one of the following: stopping the unmanned vehicle where the tag associated with the asset to be located was successfully read, hovering the unmanned vehicle where the tag associated with the asset to be located was successfully read, playing a sound on a speaker of the unmanned vehicle or the external vehicle-control device, illuminating a light of the unmanned vehicle or the external vehicle-control device, and sending a message to the external vehicle-control device or other external device for display thereon.

Example 9 includes the unmanned vehicle of any of Examples 1-8, wherein the unmanned vehicle further comprises a camera; wherein the unmanned vehicle is configured to enable images of an area associated with the asset to be located to be displayed on the external vehicle-control device.

Example 10 includes the unmanned vehicle of any of Examples 1-9, wherein the unmanned vehicle is configured to move the unmanned vehicle throughout the space to be searched by doing at least one of: moving the unmanned vehicle throughout the space to be searched autonomously; and having a person remotely pilot or drive the unmanned vehicle throughout the space to be searched.

Example 11 includes the unmanned vehicle of any of Examples 1-10, wherein the tags comprise at least one of RFID tags, WiFi tags, BLUETOOTH tags, and Zigbee tags.

Example 12 includes the unmanned vehicle of any of Examples 1-11, further comprising a positioning system to determine a current location of the unmanned vehicle, wherein the unmanned vehicle is configured to communicate the current location of the unmanned vehicle when the asset to be located has been located.

Example 13 includes a method of locating an asset having an associated tag using an unmanned vehicle having a tag reader, the associated tag having an identifier associated with the asset to be located stored therein. The method comprises moving the unmanned vehicle throughout a space to be searched for the asset to be located, performing read operations, using the tag reader in the unmanned vehicle, at various locations in the space to be searched, and, in response to successfully reading the tag associated with the asset to be located, signaling that the asset to be located has been located.

Example 14 includes the method of Example 13, wherein the unmanned vehicle comprises one of a flying drone, wheeled vehicle, and a continuous track vehicle.

Example 15 includes the method of any of Examples 13-14, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

Example 16 includes the method of any of Examples 13-15, wherein the asset to be located is deployed in one of: a space or enclosure in which the asset to be located is not normally visible and a space or enclosure in which the asset to be located is inconvenient for a person to access.

Example 17 includes the method of any of Examples 13-16, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

Example 18 includes the method of any of Examples 13-17, wherein the method further comprises: receiving the identifier associated with the asset to be located and checking if each respective associated identifier from each successfully read tag matches the identifier associated with the asset to be located. The tag associated with the asset to be located is considered to have been successfully read if the respective associated identifier from a successfully read tag matches the identifier associated with the asset to be located.

Example 19 includes the method of Example 18, wherein the identifier associated with the asset to be located is received from at least one of: a workflow management application; and an external vehicle-control device via which the identifier associated with the asset to be located has been entered.

Example 20 includes the method of any of Examples 13-19, wherein signaling that the asset to be located has been located by doing at least one of the following: stopping the unmanned vehicle where the tag associated with the asset to be located was successfully read, hovering the unmanned vehicle where the tag associated with the asset to be located was successfully read, playing a sound on a speaker of the unmanned vehicle or an external vehicle-control device, illuminating a light of the unmanned vehicle or an external vehicle-control device, and sending a message to an external vehicle-control device or other external device for display thereon.

Example 21 includes the method of any of Examples 13-20, wherein the unmanned vehicle further comprises a camera; wherein the unmanned vehicle is configured to enable images of an area associated with the asset to be located to be displayed on an external vehicle-control device.

Example 22 includes the method of any of Examples 13-21, wherein moving the unmanned vehicle throughout the space to be searched comprises doing at least one of: moving the unmanned vehicle throughout the space to be searched autonomously; and having a person remotely pilot or drive the unmanned vehicle throughout the space to be searched.

Example 23 includes the method of any of Examples 13-22, wherein the tags comprise at least one of RFID tags, WiFi tags, BLUETOOTH tags, and Zigbee tags.

Example 24 includes the method of any of Examples 13-23, wherein the unmanned vehicle comprises a positioning system to determine a current location of the unmanned vehicle, wherein the unmanned vehicle is configured to communicate the current location of the unmanned vehicle when the asset to be located has been located.

Example 25 includes a system comprising: an asset to be located, the asset to be located having an associated tag in which an identifier associated with the asset to be located is stored; an unmanned vehicle; and an external vehicle-control device; wherein the unmanned vehicle comprises: a motor configured to move the unmanned vehicle; a wireless transceiver configured to wirelessly communicate with an external vehicle-control device; a tag reader configured to perform wireless read operations, each read operation attempting to wirelessly read any tag that is within a read range of the tag reader; wherein the unmanned vehicle is configured to: move the unmanned vehicle throughout a space to be searched for the asset to be located; perform read operations, using the tag reader in the unmanned vehicle, at various locations in the space to be searched; and in response to successfully reading the tag associated with the asset to be located, signal that the asset to be located has been located.

Example 26 includes the system of Example 25, wherein the unmanned vehicle comprises one of a flying drone, wheeled vehicle, and a continuous track vehicle.

Example 27 includes the system of any of Examples 25-26, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

Example 28 includes the system of any of Examples 25-27, wherein the asset to be located is deployed in one of: a space or enclosure in which the asset to be located is not normally visible and a space or enclosure in which the asset to be located is inconvenient for a person to access.

Example 29 includes the system of any of Examples 25-28, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

Example 30 includes the system of any of Examples 25-29, wherein the tags comprise at least one of RFID tags, WiFi tags, BLUETOOTH tags, and Zigbee tags.

Example 31 includes the system of any of Examples 25-30, wherein the unmanned vehicle further comprises a positioning system to determine a current location of the unmanned vehicle, wherein the unmanned vehicle is configured to communicate the current location of the unmanned vehicle when the asset to be located has been located.

Example 32 includes an unmanned vehicle configured to scan a space, the unmanned vehicle comprising: a motor configured to move the unmanned vehicle; a communication module configured to wirelessly communicate with an external vehicle-control device; and a positioning system configured to determine a current location of the unmanned vehicle; wherein the unmanned vehicle is configured to: move the unmanned vehicle in or near the space to be scanned; capture information using the unmanned vehicle at various locations in or near the space to be scanned, each item of the captured information having associated therewith the location of the unmanned vehicle where that item was captured; and communicate the captured information to an external device.

Example 33 includes the unmanned vehicle of Example 32, further comprising a tag reader configured to perform wireless read operations, each read operation attempting to wirelessly read any tag that is within a read range of the tag reader, wherein the captured information comprises information associated with reading a tag.

Example 34 includes the unmanned vehicle of Example 33, wherein each tag is associated with an asset.

Example 35 includes the unmanned vehicle of any of Examples 32-34, further comprising a radio frequency (RF) information capture system configured to capture information about the RF environment at the current location of the unmanned vehicle, wherein the captured information comprises information captured using the RF information capture system.

Example 36 includes a method of scanning a space using an unmanned vehicle having a positioning system configured to determine a current location of the unmanned vehicle, the method comprising: moving the unmanned vehicle in or near the space to be scanned; capturing information using the unmanned vehicle at various locations in or near the space to be scanned, each item of the captured information having associated therewith the location of the unmanned vehicle where that item was captured; and communicating the captured information to an external device.

Example 37 includes the method of Example 36, wherein the unmanned vehicle further comprises a tag reader configured to perform wireless read operations, each read operation attempting to wirelessly read any tag that is within a read range of the tag reader, wherein the captured information comprises information associated with reading a tag.

Example 38 includes the method of Example 37, wherein each tag is associated with an asset.

Example 39 includes the method of any of Examples 36-38, wherein the unmanned vehicle further comprises a radio frequency (RF) information capture system configured to capture information about the RF environment at the current location of the unmanned vehicle, wherein the captured information comprises information captured using the RF information capture system.

What is claimed is:

1. An unmanned vehicle configured to locate an asset having an associated tag in which an identifier associated with the asset to be located is stored, the unmanned vehicle comprising:
a motor configured to move the unmanned vehicle;
a communication module configured to wirelessly communicate with an external vehicle-control device; and
a tag reader configured to perform wireless read operations, each read operation attempting to wirelessly read any tag that is within a read range of the tag reader;
wherein the unmanned vehicle is configured to:
move the unmanned vehicle throughout a space to be searched for the asset to be located;
perform read operations, using the tag reader in the unmanned vehicle, at various locations in the space to be searched; and
in response to successfully reading the tag associated with the asset to be located, signal that the asset to be located has been located.

2. The unmanned vehicle of claim 1, wherein the unmanned vehicle comprises one of a flying drone, wheeled vehicle, and a continuous track vehicle.

3. The unmanned vehicle of claim 1, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

4. The unmanned vehicle of claim 1, wherein the asset to be located is deployed in one of: a space or enclosure in which the asset to be located is not normally visible and a space or enclosure in which the asset to be located is inconvenient for a person to access.

5. The unmanned vehicle of claim 1, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

6. The unmanned vehicle of claim 1, wherein the unmanned vehicle is configured to:
receive the identifier associated with the asset to be located; and
checking if each respective associated identifier from each successfully read tag matches the identifier associated with the asset to be located;
wherein the tag associated with the asset to be located is considered to have been successfully read if the respective associated identifier from a successfully read tag matches the identifier associated with the asset to be located.

7. The unmanned vehicle of claim 6, wherein the unmanned vehicle is configured to receive the identifier associated with the asset to be located from at least one of:
a workflow management application; and
the external vehicle-control device via which the identifier associated with the asset to be located has been entered.

8. The unmanned vehicle of claim 1, wherein the unmanned vehicle is configured to signal that the asset to be located has been located by doing at least one of the following: stopping the unmanned vehicle where the tag associated with the asset to be located was successfully read, hovering the unmanned vehicle where the tag associated with the asset to be located was successfully read, playing a sound on a speaker of the unmanned vehicle or the external vehicle-control device, illuminating a light of the unmanned vehicle or the external vehicle-control device, and sending a message to the external vehicle-control device or other external device for display thereon.

9. The unmanned vehicle of claim 1, wherein the unmanned vehicle further comprises a camera;
wherein the unmanned vehicle is configured to enable images of an area associated with the asset to be located to be displayed on the external vehicle-control device.

10. The unmanned vehicle of claim 1, wherein the unmanned vehicle is configured to move the unmanned vehicle throughout the space to be searched by doing at least one of:
moving the unmanned vehicle throughout the space to be searched autonomously; and
having a person remotely pilot or drive the unmanned vehicle throughout the space to be searched.

11. The unmanned vehicle of claim 1, wherein the tags comprise at least one of RFID tags, WiFi tags, BLUETOOTH tags, and Zigbee tags.

12. The unmanned vehicle of claim 1, further comprising a positioning system to determine a current location of the unmanned vehicle, wherein the unmanned vehicle is configured to communicate the current location of the unmanned vehicle when the asset to be located has been located.

13. A method of locating an asset having an associated tag using an unmanned vehicle having a tag reader, the associated tag having an identifier associated with the asset to be located stored therein, the method comprising:
moving the unmanned vehicle throughout a space to be searched for the asset to be located;
performing read operations, using the tag reader in the unmanned vehicle, at various locations in the space to be searched; and
in response to successfully reading the tag associated with the asset to be located, signaling that the asset to be located has been located.

14. The method of claim 13, wherein the unmanned vehicle comprises one of a flying drone, wheeled vehicle, and a continuous track vehicle.

15. The method of claim 13, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

16. The method of claim 13, wherein the asset to be located is deployed in one of: a space or enclosure in which the asset to be located is not normally visible and a space or enclosure in which the asset to be located is inconvenient for a person to access.

17. The method of claim 13, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

18. The method of claim 13, wherein the method further comprises:
receiving the identifier associated with the asset to be located; and
checking if each respective associated identifier from each successfully read tag matches the identifier associated with the asset to be located;
wherein the tag associated with the asset to be located is considered to have been successfully read if the respective associated identifier from a successfully read tag matches the identifier associated with the asset to be located.

19. The method of claim 18, wherein the identifier associated with the asset to be located is received from at least one of:
a workflow management application; and
an external vehicle-control device via which the identifier associated with the asset to be located has been entered.

20. The method of claim 13, wherein signaling that the asset to be located has been located by doing at least one of the following: stopping the unmanned vehicle where the tag associated with the asset to be located was successfully read, hovering the unmanned vehicle where the tag associated with the asset to be located was successfully read, playing a sound on a speaker of the unmanned vehicle or an external vehicle-control device, illuminating a light of the unmanned vehicle or an external vehicle-control device, and sending a message to an external vehicle-control device or other external device for display thereon.

21. The method of claim 13, wherein the unmanned vehicle further comprises a camera;
wherein the unmanned vehicle is configured to enable images of an area associated with the asset to be located to be displayed on an external vehicle-control device.

22. The method of claim 13, wherein moving the unmanned vehicle throughout the space to be searched comprises doing at least one of:
moving the unmanned vehicle throughout the space to be searched autonomously; and
having a person remotely pilot or drive the unmanned vehicle throughout the space to be searched.

23. The method of claim 13, wherein the tags comprise at least one of RFID tags, WiFi tags, BLUETOOTH tags, and Zigbee tags.

24. The method of claim 13, wherein the unmanned vehicle comprises a positioning system to determine a current location of the unmanned vehicle, wherein the unmanned vehicle is configured to communicate the current location of the unmanned vehicle when the asset to be located has been located.

25. A system comprising:
an asset to be located, the asset to be located having an associated tag in which an identifier associated with the asset to be located is stored;
an unmanned vehicle; and
an external vehicle-control device;
wherein the unmanned vehicle comprises:
a motor configured to move the unmanned vehicle;
a wireless transceiver configured to wirelessly communicate with an external vehicle-control device;
a tag reader configured to perform wireless read operations, each read operation attempting to wirelessly read any tag that is within a read range of the tag reader;
wherein the unmanned vehicle is configured to:
move the unmanned vehicle throughout a space to be searched for the asset to be located;
perform read operations, using the tag reader in the unmanned vehicle, at various locations in the space to be searched; and
in response to successfully reading the tag associated with the asset to be located, signal that the asset to be located has been located.

26. The system of claim 25, wherein the unmanned vehicle comprises one of a flying drone, wheeled vehicle, and a continuous track vehicle.

27. The system of claim 25, wherein the asset to be located comprises: structured cabling equipment; networking equipment; power equipment; heating, ventilation, and air conditioning (HVAC) equipment; lighting equipment; elevator equipment; building-related equipment and structures; and information technology (IT) equipment.

28. The system of claim 25, wherein the asset to be located is deployed in one of: a space or enclosure in which the asset to be located is not normally visible and a space or enclosure in which the asset to be located is inconvenient for a person to access.

29. The system of claim 25, wherein the asset to be located is deployed in one of: a ceiling space between a dropped or suspended ceiling and structural ceiling; a floor space between a raised floor and a structural floor; a wall space within a wall; an underground space buried in a ground; and an inside of a vault or other enclosure.

30. The system of claim 25, wherein the tags comprise at least one of RFID tags, WiFi tags, BLUETOOTH tags, and Zigbee tags.

31. The system of claim 25, wherein the unmanned vehicle further comprises a positioning system to determine a current location of the unmanned vehicle, wherein the unmanned vehicle is configured to communicate the current location of the unmanned vehicle when the asset to be located has been located.

32. An unmanned vehicle configured to scan a space, the unmanned vehicle comprising:
a motor configured to move the unmanned vehicle;
a communication module configured to wirelessly communicate with an external vehicle-control device; and
a positioning system configured to determine a current location of the unmanned vehicle;
wherein the unmanned vehicle is configured to:
move the unmanned vehicle in or near the space to be scanned;
capture information using the unmanned vehicle at various locations in or near the space to be scanned, each item of the captured information having associated therewith the location of the unmanned vehicle where that item was captured; and
communicate the captured information to an external device.

33. The unmanned vehicle of claim 32, further comprising a tag reader configured to perform wireless read operations, each read operation attempting to wirelessly read any tag that is within a read range of the tag reader, wherein the captured information comprises information associated with reading a tag.

34. The unmanned vehicle of claim 33, wherein each tag is associated with an asset.

35. The unmanned vehicle of claim 32, further comprising a radio frequency (RF) information capture system configured to capture information about the RF environment at the current location of the unmanned vehicle, wherein the captured information comprises information captured using the RF information capture system.

36. A method of scanning a space using an unmanned vehicle having a positioning system configured to determine a current location of the unmanned vehicle, the method comprising:
moving the unmanned vehicle in or near the space to be scanned;
capturing information using the unmanned vehicle at various locations in or near the space to be scanned, each item of the captured information having associated therewith the location of the unmanned vehicle where that item was captured; and
communicating the captured information to an external device.

37. The method of claim 36, wherein the unmanned vehicle further comprises a tag reader configured to perform wireless read operations, each read operation attempting to wirelessly read any tag that is within a read range of the tag reader, wherein the captured information comprises information associated with reading a tag.

38. The method of claim 37, wherein each tag is associated with an asset.

39. The method of claim 36, wherein the unmanned vehicle further comprises a radio frequency (RF) information capture system configured to capture information about the RF environment at the current location of the unmanned vehicle, wherein the captured information comprises information captured using the RF information capture system.
